(19) United States
(12) Patent Application Publication
(10) Pub. No.: US 2025/0354432 A1
(43) Pub. Date: Nov. 20, 2025

(54) METHOD OF MAKING A TRANSPARENT LIGHTWEIGHT COATED HYBRID COMPOSITE

(71) Applicant: 3E NANO INC., TORONTO (CA)

(72) Inventors: JOSE NUNEZ-REGUEIRO, ANN ARBOR, MI (US); NAZIR PYARALI KHERANI, TORONTO (CA); ALEXEY KRASNOV, CANTON, MI (US)

(21) Appl. No.: 19/207,566

(22) Filed: May 14, 2025

Related U.S. Application Data
(60) Provisional application No. 63/647,283, filed on May 14, 2024.

(51) Int. Cl. E06B 3/673; B32B 7/12; B32B 17/10; E06B 3/66; E06B 3/67; E06B 3/677

(52) U.S. Cl. CPC E06B 3/673; B32B 7/12; B32B 17/10; E06B 3/6612; E06B 3/6715; E06B 3/6775; B32B 2255/10; B32B 2255/205; B32B 2255/28; B32B 2307/304; B32B 2307/7376; B32B 2419/00

(57) ABSTRACT

The present disclosure provides a method of making a transparent lightweight coated hybrid composite (HyC) and, particularly, to a hybrid composite coated with a thermal-insulation solar-control coating. In particular, there is disclosed the following sequence of manufacturing steps for making a coated HyC: 1) providing an individual rigid plastic pane and an individual thin glass pane; 2) preparing surface of each pane using at least one of the following methods: washing, plasma treatment, chemical activation; 3) In case of a PC pane, bonding the treated surfaces of the plastic and glass panes together by means of lamination using a thermoplastic interlayer, such as PVB, EVA, or TPU. In case of PMMA, PET, or another acrylic having a low GTP, bonding the treated surfaces of the plastic and glass panes together by means of gluing with an OCA, such as LOCA.

### FIELD

The present invention relates to a method of making a transparent lightweight coated hybrid composite and, particularly, to a composite coated with a thermal-insulation solar-control coating.

### BACKGROUND

Green movement and environmental concerns have become increasingly important for end users of transparent glazing, such as automotive OEMs (where applications include mass transit vehicles, farming and heavy equipment, recreational vehicles), architectural glazing manufacturers (where applications include mobile and manufactured homes), and businesses employing commercial refrigerators, to name a few. Among the desired attributes of transparent glazing used in the above-mentioned fields are high optical transparency, good thermal insulation, product longevity, and lighter weight. The first three attributes are achieved by using highly transparent and environmentally stable optical materials, such as glass and plastic, also more generally called polymers. Examples of plastic include polycarbonate (PC), polymethyl methacrylate (PMMA)—otherwise known as acrylic, polyethylene terephthalate (PET), etc. Examples of glass include soda-lima silicate, aluminosilicate, lithium aluminosilicate, borosilicate, etc.

The fourth aspect calls for reducing the weight of glazing by either using thinner glass, replacing glass altogether with lightweight plastic, bonding a thin glass and lightweight plastic in a so-called “composite”, arranging the two materials in an insulated glass unit (IGU) having a lighter design, or using a combination thereof. An example of a triple-pane IGU is disclosed in US20220363033A1, wherein two uncoated transparent panes are facing the interior and exterior, while the central pane comprises a combination of glass and plastic having at least one coating and laminated together in a composite. In this case, coating of a pane precedes its lamination in a composite.

WO2012051038 discloses a glass/glass laminate with the outer glass pane having a reduced thickness to lower total weight. To compensate for a loss of strength, the outer glass is chemically strengthened. The solution, however, mitigates one problem but creates another, i.e., the brittleness of the outside glass increases, thus making it more susceptible to cracking due to the possible impact by pebbles or debris. Using all-plastic glazing is very limited in applications since glass is still the material of choice in architectural and automotive glazing products, thanks to its strength and aesthetic appeal. Most end users prefer to see glass and not plastic on both exterior and interior sides of glazing.

Transparent composites comprising a combination of glass and plastic, on the other hand, enable lightweight transparent constructions and, at the same time, endows the integration of composites in certain designs with the look and feel of glass, as perceived from at least one side of a glazing. Such composites are known in art [https:H/fis.tu-dresden.de/portal/en/publications/neerofacade—a-new-concept-of-facade-design-with-lightweight-thin-glassplasticcomposite-panels(48c37354-e449-4f49-aadb-57eca148f625).html].

Of particular interest are combinations of thick rigid plastic and thin glass bonded together with a bonding material. In the case of a PC pane having a glass transition point (GTP) of 147° C., a thermoplastic bonding material such as polyvinyl butyral (PVB), ethylene vinyl acetate (EVA), thermoplastic polyurethane (TPU), or ionomer resins can be used. In the case of PMMA or PET having respective glass transition points of 102° C. and 67-81° C., an optically clear adhesive (OCA) requiring no heat activation can be used. Examples include the application of a liquid optically clear adhesive (LOCA), such as an acrylic- or silicone-based adhesive followed by curing with ultraviolet (UV) light.

When assembled in an IGU, such as double- or triple-pane fenestration, light-weight composites are easier to install and require a thinner sash and frame compared to their thicker glass counterparts, and thus ultimately offering an IGU with reduced total weight. An additional benefit of a composite is its improved impact resistance. Examples include architectural transparent facades, automotive glazing, and hurricane-rated and vandal-resistant glass. It is worth noting in this regard that PMMA, for example, has greater impact strength than conventional soda-lime glass and similar impact strength compared to tempered glass. If it does break, PMMA sheets usually shatter into large shards with edges much smoother than those of broken glass, thus offering improved safety. In addition, PMMA has a lower thermal conductance compared to glass (1.3 BTU/(hr-ft²)(F/inch) for PMMA vs 5.3 BTU/(hr-ft²)(F/inch) for glass). Finally, PMMA has higher optical transmission and clarity compared to conventional glass, which helps to compensate for loss of transparency in cases where functional coatings are applied to the glazing.

Such hybrid transparent composites can be used as standalone structures or be combined with other panes of glass or plastic in an IGU, such as commercial or residential fenestrations or commercial refrigeration doors [U.S. Pat. No. 6,148,563].

CA2375256, U.S. Pat. No. 5,028,759A, and US20100257815A1 disclose disposing an energy-efficient solar-control or low-emissivity (low-E) coating on a pane of glass or plastic and then assembling it into a lightweight glass/plastic composite to reflect or absorb a portion of infrared (IR) light, thus further improving thermal insulation of the structure. Both types of the coatings are discussed in detail in https://doi.org/10.1016/j.optmat.2023.113807. Depositing a thin-film coating on glass or plastic and then bonding them together into a composite, however, is quite challenging. On a large industrial scale, the coating is typically applied in an economic way by means of physical vapor deposition, and more specifically, by sputter deposition in a horizontal coater. The sputtering process employs a set of vacuum chambers filled with working gas, such as argon. Under a high voltage, plasma is formed inside each chamber, leading to the deposition of material from a sputtering target on a glass or plastic pane. The pane moves from one sputtering chamber to another while in direct contact with a set of conveyor rollers. The rollers are inevitably covered with an unwanted layer of debris formed by sputtered materials. The debris is harmless to glass but leaves noticeable scratches on the surface of plastic. Further, the build-up of sputtered material on the rollers tends to be greater in the central region of the coater as opposed to that on the periphery, resulting in differential roller speed which in turn further exacerbates surface marking of the substrates.

To prevent the plastic from scratches and dents, special full-size carriers must be used. This significantly adds to production costs. Coating a large pane of thin glass is also a challenge. Thin glass panes are known to suffer from a higher yield loss during handling, cutting, and running through a coater. Employing a large-size carrier also adds to production costs. Yet another challenge is bonding one coated pane to an uncoated pane. Any yield loss at this stage would be even more expensive since any subsequent production step has a higher cost of failure, and the cost of coating failure is higher compared to the cost of breaking uncoated materials.

Another problem with coating a plastic pane first and then laminating it to a glass pane is a relatively high temperature (in excess, for example, of the GTP for PMMA) required by the thermoplastic interlayer, such as PVB, to bond the two panes together.

With ever increasing demand for lightweight thermal insulation and impact resistant architectural and automotive glazing, it would be desirable to provide a method of manufacturing of a coated composite which overcomes the abovementioned deficiencies of prior art.

### SUMMARY

The present invention solves the problems of susceptibility of a plastic pane to scratches and dents from conveyor rollers during the deposition process and the high-cost associated with yield loss of an uncoated thin glass pane by providing a method comprising a new sequence of manufacturing steps. This sequence results in a coated transparent lightweight glazing denoted here as “hybrid composite” and abbreviated HyC.

In an embodiment, the present invention discloses the following sequence of manufacturing steps for making a coated HyC: 1) providing an individual rigid plastic pane and an individual thin glass pane; 2) preparing surface of each pane using at least one of the following methods: washing, plasma treatment, chemical activation; 3) In case of a polycarbonate (PC) pane, bonding the treated surfaces of the plastic and glass panes together by means of lamination using a thermoplastic interlayer, such as PVB, EVA, or TPU. In case of PMMA, PET, or another acrylic having a low GTP, bonding the treated surfaces of the plastic and glass panes together by means of gluing with an optically clear adhesive (OCA), such as liquid optically clear adhesive (LOCA). Higher GTP PMMA could be potentially laminated at a slightly lower temperature using polyvinyl butyral (PVB), ethylene vinyl acetate (EVA), or thermoplastic polyurethane (TPU). Alternatively, localized heating techniques can be utilized whereby the thermoplastic interlayer is in a quasi-liquid state and can bond with a low glass transition point (GTP) polymer. This step completes the formation of a HyC, thus making it a rigid and mechanically durable bonded pane; 4) depositing a solar-control coating or low emissive coating on the plastic surface of the hybrid composite. This step is advantageous over coating a single plastic substrate since it has the more durable glass side of the HyC in direct contact with conveyor rollers during the deposition process.

The sequence, therefore, is different from that used in the prior art, in which coating one or more surfaces of individual panes is provided followed by bonding them together in a composite.

The solar-control coating of the present invention may comprise, as is detailed in https://doi.org/10.1016/j.optmat.2023.113807, one or more thin layers of silver or another thin substantially transparent metal or metal alloy embedded in a thin-film stack of dielectrics and other materials. In a preferred embodiment, solar-control stack comprises one or two silver layers sandwiched between a set of dielectrics. The coating may also comprise another solar-control or low-E material, such as a transparent conductive oxide (TCO). Examples include indium tin oxide (ITO), indium zinc oxide (IZO), etc.

In an embodiment, a plastic pane, prior to being bonded to glass, is primed by a hard coating (on the unbonded side), such as wet-processed siloxane. After thermal curing or exposure to UV light, the hard coating forms a glassy surface. The thickness of the hard coating after curing may be several microns in thickness.

In an embodiment, the cured hard coating is textured or micropatterned by one of the following methods: micromachining, embossing, laser scribing, chemical patterning, etc. The purpose of this step is threefold: a) to improve adhesion of the solar-control coating to the plastic pane; b) to enhance the scratch resistance of the exposed surface of the plastic pane, which can be appreciated during cutting, handling, and loading the composite into the coater; and c) to mitigate the difference between the coefficients of thermal expansion of glass and plastic at changing temperatures, which may result in a greater linear expansion and contraction of the plastic compared to glass. The patterning when appropriately configured may also endow the functional property of causing solar light to undergo more upward reflection, toward the upper atmosphere and outer space.

In an embodiment, an additional thin glass pane may be laminated or glued (depending on the plastic type) to the coating surface of the coated HyC.

In an embodiment, a double-pane insulated glass unit (IGU) glazing is made by assembling in a frame a single coated or uncoated glass or plastic pane facing the exterior and a coated HyC facing the interior (occupant side) with its glass surface and spaced from said single coated or uncoated glass or plastic pane thus creating an IGU cavity.

In an embodiment, a triple-pane IGU glazing is made by assembling in a frame a single coated or uncoated glass or plastic pane facing the exterior, a coated hybrid composite facing the interior with its glass surface, and a central single pane made of a coated or uncoated thin glass or plastic and positioned between said coated or uncoated single glass or plastic pane and coated HyC thus creating two IGU cavities.

In an embodiment, a double-pane IGU glazing is made by assembling in a frame a single coated or uncoated glass or plastic pane facing the interior and a coated HyC facing the exterior with its glass surface and spaced from the single coated or uncoated glass or plastic pane, thus leaving the coated plastic surface positioned inside the IGU.

In an embodiment, a triple-pane IGU glazing is made by assembling in a frame a single coated or uncoated glass or plastic pane facing the interior, a coated HyC facing the exterior with its glass surface, and a central single pane made of uncoated thin glass or plastic and positioned between said uncoated glass pane and coated HyC.

In embodiments, the preferred alignment of the panes in an IGU is parallel to one another.

In some embodiments, at least one pane of an IGU may be tilted in relation to other pane or panes.

In an embodiment, two panes of a HyC may be non-parallel to each other if, e.g., laminated with a wedged thermoplastic bonding material.

In embodiments, an IGU may be filled with air or an inert gas, such as argon, krypton, etc. or a mixture of gases.

In an embodiment, said coated HyC may be used as secondary glazing, that is, to retrofit existing glazing by installing it on either exterior or interior side of the unit.

In embodiments, said coated HyC and an IGU comprising said coated HyC may be used without any limitations as glazing for architectural fenestrations, automobiles, trains, airplanes, other vehicles, as well as doors of commercial refrigerators and coolers.

### BRIEF DESCRIPTION OF THE DRAWINGS

The present invention can be understood by considering the following drawings and the legend for the reference numerals presented further below:

FIG. 1 is a schematic representation of a process flow diagram of preparing a bonded coated composite according to prior art.

FIG. 2 is a schematic representation of a process flow diagram for making a coated hybrid composite (HyC).

FIG. 3 is a schematic representation of a process flow diagram for making an enhanced coated HyC having an additional pane of thin glass bonded to the coating side.

FIG. 4A is a schematic representation of providing glass and plastic individual panes.

FIG. 4B is a schematic representation of a step involving surface treatment of the surfaces of the panes being bonded together.

FIG. 4C is a schematic representation of bonding the panes together with their treated surfaces, the step resulting in a HyC.

FIG. 4D is a schematic representation of a step involving coating the hybrid composite with a solar-control or low-E coating and applying an optional hard coating with or without its subsequent texturing or patterning.

FIG. 4E is a schematic representation of a step involving bonding additional pane of thin glass to the coated HyC, thus making an enhanced coated HyC.

FIG. 5A is a schematic representation of a resultant coated HyC.

FIG. 5B is a schematic representation of a coated HyC with optional hard coating.

FIG. 5C is a schematic representation of an enhanced coated HyC.

FIG. 5D is a schematic representation of an enhanced coated HyC with optional hard coating.

FIG. 6A is a schematic representation of a double-pane insulated glass unit (IGU) comprising a coated HyC on the interior side.

FIG. 6B is a schematic representation of a double-pane IGU comprising an enhanced coated HyC on the interior side.

FIG. 7A is a schematic representation of a double-pane IGU comprising a coated HyCon the exterior side.

FIG. 7B is a schematic representation of a double-pane IGU comprising an enhanced coated HyC on the exterior side.

FIG. 8A is a schematic representation of a triple-pane IGU comprising a coated HyC on the interior side.

FIG. 8B is a schematic representation of a triple-pane IGU comprising an enhanced coated HyC on the interior side.

FIG. 9A is a schematic representation of a triple-pane IGU comprising a coated HyCon the exterior side.

FIG. 9B is a schematic representation of a triple-pane IGU comprising an enhanced coated hybrid composite on the exterior side.

FIG. 10A is a schematic representation of a triple-pane IGU comprising an coated hybrid composite on both interior and exterior sides.

FIG. 10B is a schematic representation of a triple-pane IGU comprising an enhanced coated HyC on both interior and exterior sides.

FIG. 11 is a schematic representation of a VIG comprising an enhanced coated HyC on the interior side.

The accompanying drawings, which are incorporated in and form a part of this description, illustrate various embodiments of the invention, and together with the description, illustrate the principles of the invention, and enable those skilled in the art to make and use the invention.

### DEFINITION OF THE REFERENCE NUMERALS USED IN THE DRAWINGS

400, 500, 600, 700, 800, 900, 1000, 1100 Glass pane
501, 601, 701, 801, 901, 1001 Coated hybrid composite HyC
1001′ A second (“mirror” double) enhanced coated HyC on the interior side
502 Coated hybrid composite with optional hard coating
503, 603, 703, 803, 903, 1003, 1103 Enhanced coated HyC
1003′ A second (“mirror” double) enhanced coated HyC on the interior side
504 Enhanced coated HyC with optional hard coating
405, 505, 605, 705, 805, 905, 1005, 1105 Plastic pane
606 Double-pane insulated glass unit (IGU) with HyC composite on interior side
607 Double-pane IGU with enhanced coated HyC on interior side
708 Double-pane IGU with coated HyC on exterior side
709 Double-pane IGU with enhanced coated HyC on exterior side
410 Process step involving surface treatment of glass pane
811 Triple-pane IGU with coated hybrid composite on interior side
812 Triple-pane IGU with enhanced coated HyC on interior side
913 Triple-pane IGU with coated HyC on exterior side
914 Triple-pane IGU with enhanced coated HyC on exterior side
415 Process step involving surface treatment of plastic pane
1116 Vacuum insulation unit with enhanced coated HyC on interior side
420, 520, 620, 720, 820, 920, 1020, 1120 First bonding layer
425, 525 Optional hard coating
430, 530, 630, 730, 830, 930, 1030, 1130 Solar-control or low-E coating
435, 535, 635, 735, 835, 935, 1035, 1135 Second bonding layer
440, 540, 640, 740, 840, 940, 1040, 1149 Second pane of thin glass of enhanced HyC
645, 745, 845, 945, 1045, 1145 First pane of single glass or plastic in an isolated unit (IGU or VIG)
650, 750, 850, 950, 1050, 1150 A coating on pane of single glass or plastic
655, 755, 855, 955, 1055, 1155 Frame
860, 960 Second pane of single glass or plastic in an isolation glass unit
865, 965 Optional coating on second pane of single glass or plastic in an isolation glass unit
1170 Spacers
1175 Vacuum

### DETAILED DESCRIPTION

A detailed description is provided below to facilitate a thorough understanding of the disclosed embodiments and connections thereof. The description is not limited to any particular example included herein.

Various embodiments and aspects of the disclosure will be described with reference to the details discussed below. The following description and drawings are illustrative of the disclosure and are not to be construed as limiting the disclosure. Numerous specific details are described to provide a thorough understanding of various embodiments of the present disclosure. The Figures are not to scale. Further, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

The following terminology is used to describe the subject of the invention.

A glazing is an article comprised at least one layer of a transparent material which serves to provide for the transmission of light and/or to provide for viewing of the side opposite the viewer and which is mounted in an opening in a building, vehicle, wall or roof or other framing member or enclosure.

A composite is a structure comprising a pane of an optically transparent material coupled with a pane of another optically transparent material by means of bonding, such as lamination using an interlayer of thermoplastic material (e.g., polyvinyl butyral (PVB), thermoplastic polyurethane (TPU)) or gluing with, e.g., a liquid optically clear adhesive (LOCA).

A hybrid composite (HyC)—the term introduced in the present invention to distinguish from prior art—is a structure comprising a rigid pane of optically transparent plastic bonded with a pane of optically transparent thin glass.

In the first aspect of the present invention, a method of making a coated hybrid composite is provided, the method comprising the following sequence of at least four manufacturing steps: 1) providing an individual rigid plastic pane and an individual thin glass pane; 2) preparing surface of each pane using at least one of the following methods: washing, plasma treatment, laser cleaning, chemical activation, or any other suitable method; 3) In case of a polycarbonate (PC) pane, bonding the treated surfaces of the plastic and glass panes together by means of lamination using a thermoplastic interlayer, such as PVB, EVA, or TPU. In case of PMMA or another acrylic having a low glass transition point (GTP), bonding the treated surfaces of the plastic and glass panes together by means of gluing with a LOCA. This step completes the formation of HyC, thus making it a rigid and mechanically durable bonded pane—a substrate for the next step; 4) depositing a solar-control or a low-E coating on the plastic surface of the HyC, thus providing the more durable glass side of the HyC in direct contact with conveyor rollers which minimizes susceptibility to scratches during the deposition process in an economical way.

Step 2) of the abovementioned list is focused on improving the adhesion of the coating to the surface by increasing the surface free energy (i.e., increasing the number of free atomic bonds). Washing may include applying an aqueous solution of any suitable detergent, then thoroughly rinsing the surface with deionized water followed by drying it with forced air. Plasma treatment employs the exposure of the surface to a highly ionized gas created by applying a high voltage to a gas or a mixture of gases. Laser cleaning uses defocused laser beam to remove debris, organic residue, or other imperfections from the surface.

The resultant rigid lightweight (compared to, e.g., a glass/glass laminate of the same thickness) structure is then used as a substrate for the deposition of a coating on its plastic surface. The plastic surface faces the sputtering targets during the deposition, while the glass surface of the HyC is in direct contact with conveyor rollers. This arrangement mitigates the risk of the plastic surface to be scratched by debris from the rollers as well as reduces the risk of high-cost associated yield loss during handling a bonded HyC as opposite to handling a coated individual plastic or thin glass pane. In addition, the new sequence of processing steps places the lamination at an elevated temperature before the process of coating, thus mitigating the risk of the coating failure due to mismatch in the coefficients of thermal expansion of the two materials.

Plastic can be made of any polymer material, such as polymethyl methacrylate (PMMA), PC, polyethylene terephthalate (PET), etc. The thin glass pane can be of one of the following categories: soda-lima silicate, aluminosilicate, lithium aluminosilicate, borosilicate, etc. Soda-lime glass, also known as float glass, can be annealed (gradually cooled down through the glass transitioning temperature point when being pulled from the kiln of the glass production float line), heat tempered (is rapidly cooled by forced air), heat strengthened (is similar to tempered but having a lower level of residual mechanical stress), chemically tempered (being subjected to ion exchange to create a required level of surface tension). A HyC is characterized by two major surfaces and has a relatively uniform thickness.

A solar-control coating is typically a thin-film coating applied by any means of deposition, such as physical vacuum deposition (PVD) or chemical vapor deposition (CVD). An example of PVD is magnetron sputtering. An example of CVD is plasma-enhanced chemical deposition. A typical solar-control coating comprises at least one ultra-thin substantially optically transparent metal layer, such as silver, sandwiched between a set of dielectric layers. The more metal layers used in the coating, the better the ratio of optical transmission to the reflection of infrared light can be achieved. The typical number of silver layers in a sputtered solar-control coating is between one and three. Other types of solar-control coatings can also be applied using other methods, such as pyrolytic, spray, dip, sol-gel, etc.

One of the significant advantages of a silver based solar-control coating is the fact that silver allows the sharpest transition of its optical transmission curve between the visible and near-IR spectral ranges. In other words, it enables the coating to be highly transparent in the visible while blocking the IR light, thus providing thermal comfort to the building or vehicle occupants. On the flip side, silver-based coatings are known to be susceptible to environmental corrosion when applied on an exposed surface, even when protected by the deposition of additional thin-film layers. Also, thin silver-based coatings are so-called “soft coatings” which are prone to mechanical damage. For these reasons, a solar-control coating in the present invention is applied on the side of a HyC which is protected from the elements by either facing another pane of the glazing or by encapsulation with another optically transparent pane via lamination or another type of bonding. The coating, however, may comprise another, non-silver solar-control or low-E material, such as a transparent conductive oxide (TCO). Examples include, without limitation, indium-tin-oxide (ITO), indium-zinc-oxide (IZO), or any other transparent conductive oxide.

The solar-control coating of the present invention may comprise one or more thin layers of silver or another thin transparent metal or metal alloy embedded in a thin-film stack of dielectrics and other materials. In a preferred embodiment, solar-control stack comprises two silver layers sandwiched between a set of dielectrics. The coating may also be a low-E coating.

In an embodiment, a plastic or PC pane, prior to being bonded to glass, is primed with a hard coating, such as wet-processed siloxane. After exposure to ultraviolet (UV) light, the hard coating forms a glassy surface. The thickness of the hard coating after curing may be between several microns to several millimeters. The hard coating may be applied to both sides or only one side of the polymer pane considering process and application specifics.

In an embodiment, the cured hard coating is micropatterned or textured by one of the following methods: micromachining, embossing, laser scribing, chemical patterning, etc. The purpose of this step is threefold: a) to improve adhesion of the solar-control coating to the plastic pane; b) to enhance scratch resistance of the exposed surface of the plastic pane, which can be appreciated during cutting, handling, and loading the composite into the coater; and c) to mitigate the difference between the coefficients of thermal expansion of glass and plastic at changing temperatures, which may result in a greater linear expansion and contraction of the plastic compared to glass.

In a second aspect of the invention, a method is provided to bond said coated hybrid composite to a second pane of thin glass with a second interlayer of thermoplastic or an OCA, thus forming a HyC with a solar-control coating located between the plastic layer and the second layer of bonding material.

In a third aspect of the invention, a method is provided to integrate said coated HyC into an insulated glass unit (IGU).

In an embodiment, a double-pane IGU glazing is made by assembling in a frame a single coated or uncoated glass or plastic pane facing the exterior and a coated HyC facing the interior with its glass surface and spaced from said single coated or uncoated glass or plastic pane.

In an embodiment, a triple-pane IGU glazing is made by assembling in a frame a single coated or uncoated glass or plastic pane facing the exterior, a coated HyC facing the interior with its glass surface, and a central single pane made of a coated or uncoated glass or plastic and positioned between said coated or uncoated single glass pane and coated HyC.

In an embodiment, a double-pane IGU glazing is made by assembling in a frame a single coated or uncoated glass or plastic pane facing the interior and a coated HyC facing the exterior with its glass surface and spaced from the single coated or uncoated glass or plastic pane, thus leaving the coated plastic surface protected inside the IGU.

In an embodiment, a triple-pane IGU glazing is made by assembling in a frame a single coated or uncoated glass or plastic pane facing the interior, a coated HyC facing the exterior with its glass surface, and a central single pane made of uncoated glass or plastic positioned between said uncoated glass pane and coated hybrid composite.

In embodiments, the preferred alignment of the panes in an IGU is parallel to one another.

In some embodiments, at least one pane of an IGU may be tilted in relation to other pane or panes.

In an embodiment, two panes of a HyC may be non-parallel to each other if laminated with a wedged thermoplastic bonding material.

In embodiments, said coated HyC and an IGU comprising said coated HyC may be used without any limitations as glazing for architectural fenestrations, automobiles, trains, airplanes, other vehicles, as well as doors of commercial refrigerators and coolers.

In some embodiments, spaces between the panes in an IGU glazing can be filled with air or an inert gas, such as, without any limitation, argon, or krypton, or any combination thereof to improve the thermal performance of the unit.

In an embodiment, said coated HyC may be used to retrofit existing IGU glazing by installing it on either exterior or interior side of the unit.

In an embodiment, said triple-pane coated composite, along with a separate pane of glass which is spaced from it using spacers, is part of a vacuum insulated glass (VIG) unit. As the name implies, the space between said composite and the glass pane is filled with vacuum.

In some embodiments, the thickness of the thin glass pane in a HyC ranges from about 0.025 to about 2.1 mm, and preferably from about 0.5 to about 1.5 mm. The thickness of the plastic pane ranges from about 1.0 to about 16.0 mm, and preferably from about 3.0 to about 6.0 mm.

In some embodiments, the thickness of the intermediate thermoplastic bonding layer ranges from about 0.2 to about 2.4 mm, and preferably from about 0.3 to about 0.8 mm.

In some embodiments, the thickness of the solar-control coating is not greater than 0.7 micron; preferably not greater than 0.5; and yet more preferably not more than 0.3 micron.

In some embodiments, the total thickness of a coated HyC is not greater than 12 mm; preferably not greater than 8.0 mm; and yet more preferably not greater than 6.0 mm.

In an embodiment, a double-pane IGU comprising a coated HyC has the uncoated glass pane thickness ranging from about 2.0 to about 16.0 mm, and preferably from about 3.0 to about 6.0 mm.

In an embodiment, a triple-pane IGU comprising a coated HyC has the uncoated glass pane thickness ranging from about 2.0 to about 16.0 mm, and preferably from about 3.0 to about 6.0 mm and the uncoated plastic pane thickness ranging from about 1.0 and 10.0 mm; preferably from about 2.0 to about 6.0 mm; and yet more preferably from about 2.5 to about 5.0 mm.

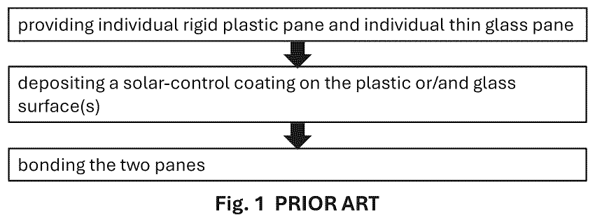

FIG. 1 demonstrates a process flow diagram of preparing a coated bonded composite according to prior art. Plastic and glass individual panes are provided in the first step. In the second step, one of the panes is coated with a solar-control coating on the surface of either pane. The coated and uncoated panes are then bonded together. The process makes the plastic pane susceptible to scratches from conveyor rollers. The process also makes the thin glass pane susceptible to breakage during the coating deposition.

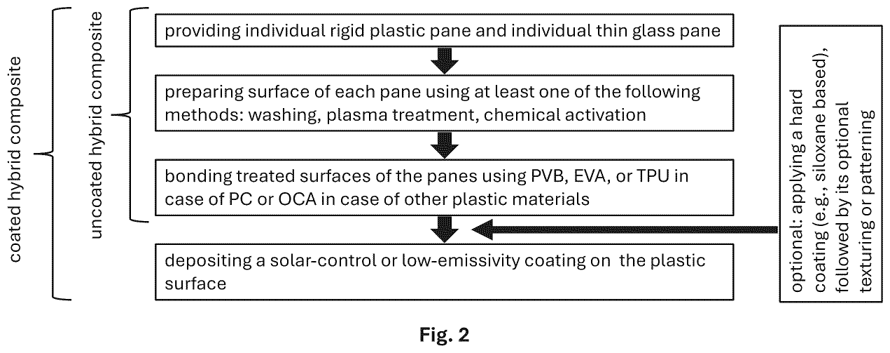

FIG. 2 demonstrates a process flow diagram of preparing a coated HyC according to the present invention. Plastic and glass individual panes are provided in the first step. Plastic can be PMMA, PC, PET, etc. Glass can be soda-lima silicate, aluminosilicate, lithium aluminosilicate, borosilicate, etc.

In the second step, one surface of each pane is treated using one of the following methods: washing, plasma treatment, laser treatment, or chemical activation. The purpose of this step is to activate the surface by increasing its energy, i.e., by increasing the number of active chemical bonds available for pairing, thus resulting in an improved adhesion. In the third step, the two panes are bonded together with their treated surfaces. When polycarbonate having a relatively high GTP is used as plastic, bonding material may comprise thermoplastic bonding, such as PVB, EVA, or TPU since they require a relatively high activation temperature which can be withstood by polycarbonate. If PMMA or another acrylic having a low GTP is used, thermoplastic bonding materials cannot be applied since the high activation temperature will soften the plastic pane. In this case, the two panes are bonded using a LOCA. This step completes the fabrication of a lightweight HyC which can later be used as a rigid lightweight substrate for coating in step four. The hybrid composite, with its glass surface facing down and touching conveyor rollers, is admitted in the coater and enters the first deposition chamber filled with a working gas, such as argon, or a mixture of gases, such as argon and oxygen. Atoms of a material, such as a dielectric or a metal, are dislodged from a sputtering target under the bombardment by plasma species and get deposited on the plastic surface of the HyC. Different chambers are loaded with sputtering targets composed of desired material or materials. Moving on the conveyor from chamber to chamber, the HyC gets deposited with a stack of thin layers, such as a solar-control or a low-E coating. Before the deposition step, an optional hard coating, such as that comprised of siloxane, may be used on the bare plastic surface of the hybrid composite by wet processing followed by thermal or ultraviolet curing. The purpose of this coating is to prime the plastic surface for better deposition quality of the solar-control or low-E coating. For better adhesion and to mitigate the difference in the coefficient of thermal expansion between the solar-control or low-E coating and the substrate, the hard coating may be textured or patterned. As a result of these steps, a lightweight coated HyC is formed.

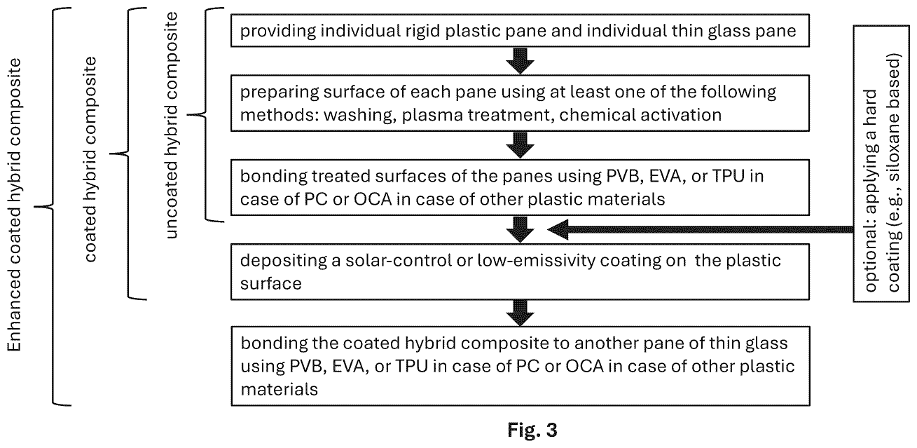

FIG. 3 demonstrates a process of further improving the coated hybrid composite. The process is similar to that of FIG. 2 but has an additional step of bonding a second pane of thin glass to the coating side of the coated HyC. The resultant rigid transparency is denoted as “enhanced coated hybrid composite”. Among the benefits of this addition are better protection of the coating, especially in case of the environmentally sensitive silver-based solar control coating, from the elements and mechanical scratches as well as preventing possible outgassing from plastic when the composite is used in a vacuum insulating unit, to name a few. The second thin glass pane is bonded to the coated hybrid composite using PVB, EVA, or TPU in case of PC or OCA in case of other plastic materials, such as PMMA, having a low glass transition point.

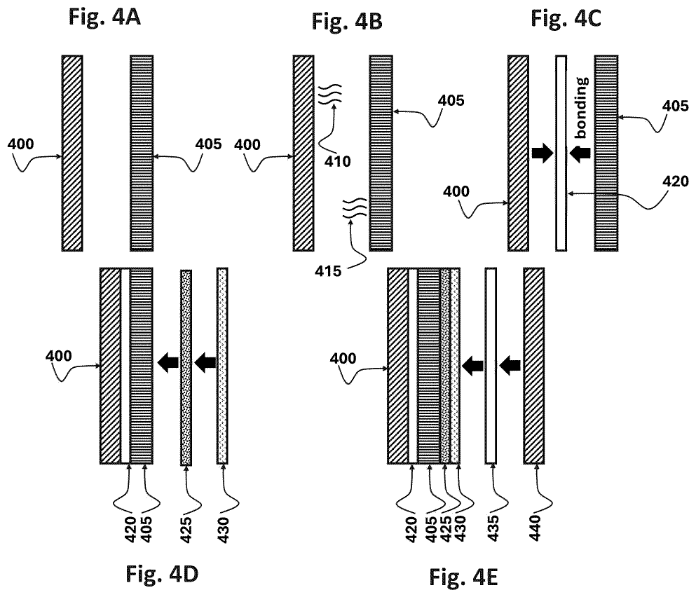

FIG. 4A-4E demonstrate individual steps of each process in finer detail.

FIG. 4A depicts providing transparent individual single panes of thin glass 400 and rigid plastic 405. The thickness of plastic pane ranges from about 1.0 to about 16.0 mm, and preferably from about 3.0 to about 6.0 mm. The thickness of glass pane ranges from about 0.025 to about 2.1 mm, and preferably from about 0.5 to about 1.5 mm.

FIG. 4B depicts applying surface preparation step 410 to the glass pane 400 and surface preparation step 415 to the plastic pane 405. This step may include washing the surface with an aqueous solution of any suitable detergent and then thoroughly rinsing the surface followed by drying it with forced air. Plasma treatment employs the exposure of the surface to a highly ionized gas created by applying a high voltage to a gas or a mixture of gases filling the sputtering chamber. Laser cleaning uses defocused laser beam to remove debris, organic residue, or other imperfections from the surface.

FIG. 4C demonstrates bonding the treated surfaces of glass pane 400 and plastic pane 405 together with bonding material 420. In case when polycarbonate having a higher GTP is used as a plastic material, bonding may include a thermoplastic interlayer, such as PVB, EVA, or TPU. The thickness of the layer ranges from about 0.2 to about 2.4 mm, and preferably from about 0.3 to about 0.8 mm. In the case of plastics with a lower GTP, such as PMMA, bonding is done by gluing using a LOCA. In this case the thickness of the bonding layer is from about 0.0001 to about 1.0 mm. As a result of the bonding process, a rigid and mechanically robust HyC is formed.

FIG. 4D demonstrates coating the hybrid composite with solar-control or low-emissivity coating 430. Primer coating 425, denoted here as “hard coating”, may be additionally applied on the plastic surface of the HyC before depositing solar-control or low-E coating 430. Hard coating 425 may or may not be textured or patterned. Texturing or patterning may improve the adhesion of a solar-control or low-emissivity coating 430 as well as to mitigate the risk of the coating cracking or/and crack propagation due to the difference in the coefficients of thermal expansion between the hard coating 425 and the composite. The coating 430 is applied on the plastic surface of hybrid composite with or without hard coating 425. As a result of the step of FIG. 4D, a coated lightweight HyC is formed. The composite in this form may later be used in an IGU.

FIG. 4E demonstrates bonding of coated hybrid composite with additional pane of thin glass 440 using a layer of bonding material 435. The resultant transparency is an “enhanced coated HyC” which offers a better mechanical and chemical protection of the coating and adds protection from outgassing of exposed plastic when used in a VIG. Bonding layer 435 is PVB, EVA, or TPU in case of PC used as plastic or OCA in case of other plastic materials, such as PMMA, having a low glass transition point.

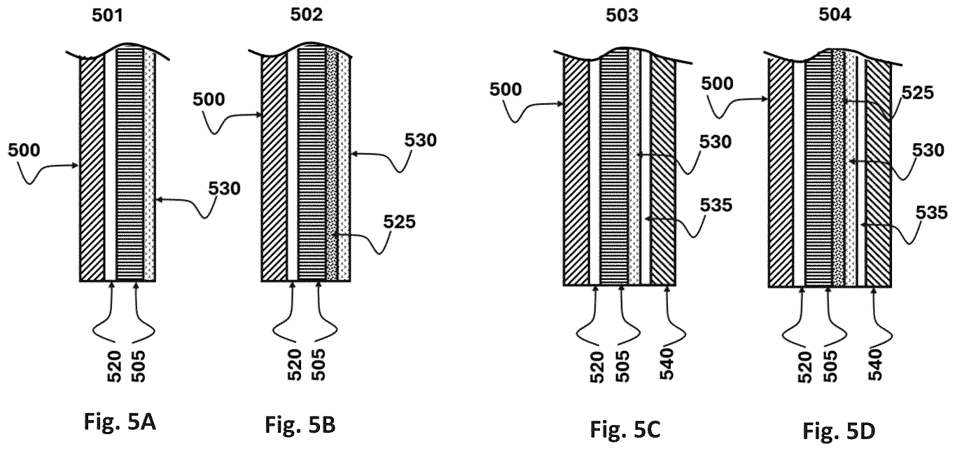

FIG. 5A demonstrates a resultant coated HyC 501 with no hard coating.

FIG. 5B demonstrates a resultant coated hybrid composite 502 with hard coating 525.

FIG. 5C demonstrates a resultant enhanced coated HyC 503 with no hard coating.

FIG. 5D demonstrates a resultant enhanced coated hybrid composite 504 with hard coating 525.

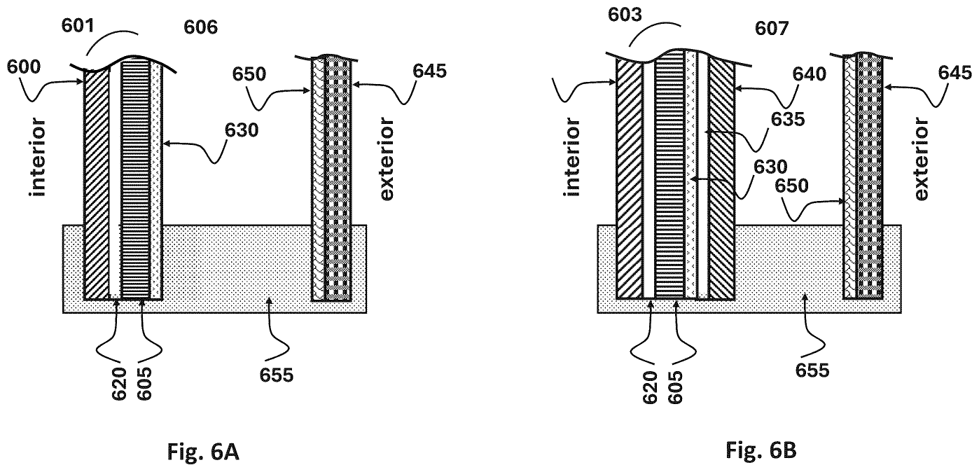

FIG. 6A demonstrates an IGU comprising coated HyC 601 on the interior side and single transparent pane 645, such as glass or plastic on the exterior side. Pane 645 may optionally be coated with coating 650, such as a solar-control or ant-reflective coating. Coated hybrid composite 601 faces the interior with its glass side to give the lightweight glazing the feel and look of glass, at least on one side, while protecting the coating within the IGU enclosure. Only the option with no hard coating is shown.

FIG. 6B demonstrates an IGU comprising enhanced coated HyC 603 on the interior side and single transparent pane 645, such as glass or plastic on the exterior side. Pane 645 may optionally be coated with coating 650, such as a solar-control or ant-reflective coating. The enhanced coated hybrid composite faces the interior with its glass side to give the lightweight glazing the feel and look of glass, at least on one side of the glazing. Only the option with no hard coating is shown.

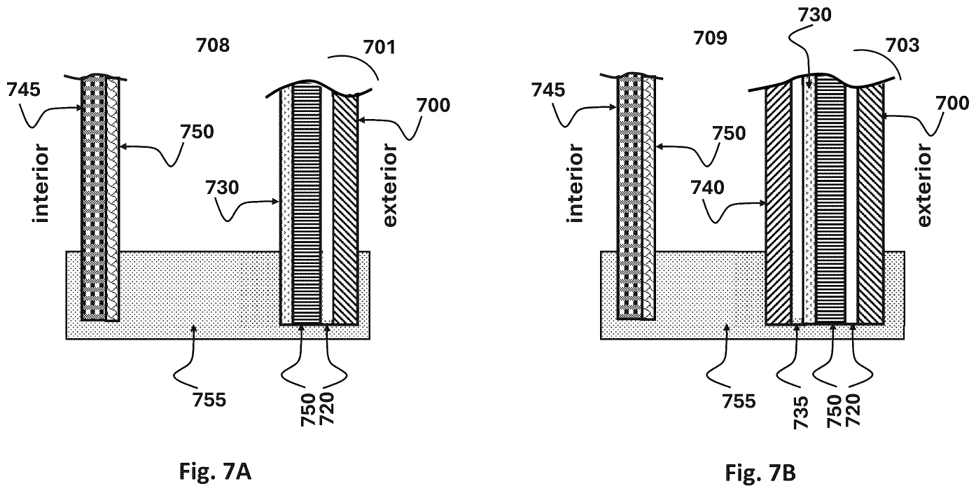

FIG. 7A demonstrates an IGU comprising coated HyC 701 on the exterior side and single transparent pane 745, such as glass or plastic on the interior side. Pane 745 may optionally be coated with coating 750, such as a solar-control or ant-reflective coating. The coated hybrid composite faces the exterior with its glass side to give the lightweight glazing the feel and look of glass, at least on one side of the glazing. Only the option with no hard coating is shown.

FIG. 7B demonstrates an IGU comprising enhanced coated hybrid composite 703 on the exterior side and single transparent pane 745 on the interior side. Pane 745 may optionally be coated with coating 750, such as a solar-control or ant-reflective coating. The enhanced coated HyC faces the exterior with its glass side to give the lightweight glazing the feel and look of glass, at least on one side of the glazing. Only the option with no hard coating is shown.

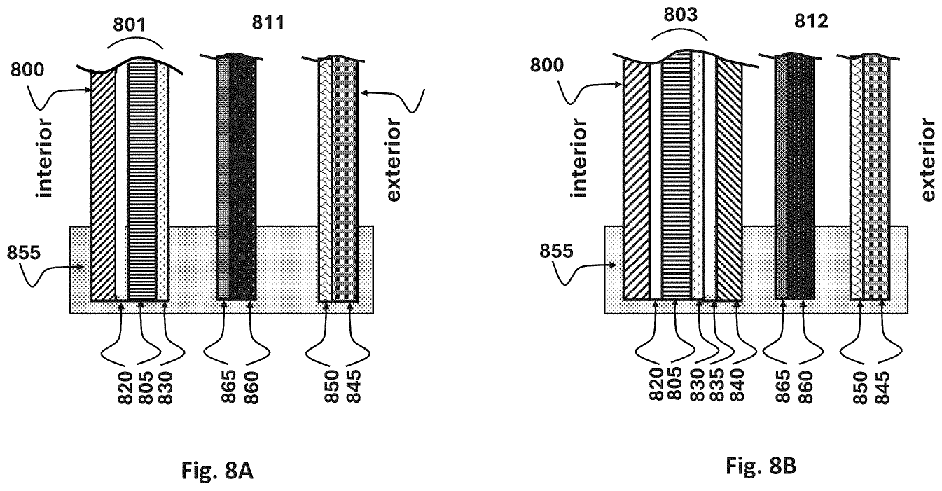

FIG. 8A demonstrates an IGU comprising coated hybrid composite 801 on the interior side, single transparent pane 845, such as glass or plastic, on the exterior side, and central single pane 860, such as glass or plastic. Pane 860 may optionally be coated with coating 865, such as a solar-control or ant-reflective coating. The purpose of central pane 860 is to further improve thermal insulation of the IGU. Only the option with no hard coating is shown.

FIG. 8B demonstrates an IGU comprising enhanced coated HyC 803 on the interior side, single transparent pane 845, such as glass or plastic on the exterior side, and central single pane 860, such as glass or plastic. Pane 860 may optionally be coated with coating 865, such as a solar-control or ant-reflective coating. The purpose of central pane 860 is to further improve thermal insulation of the IGU. Only the option with no hard coating is shown.

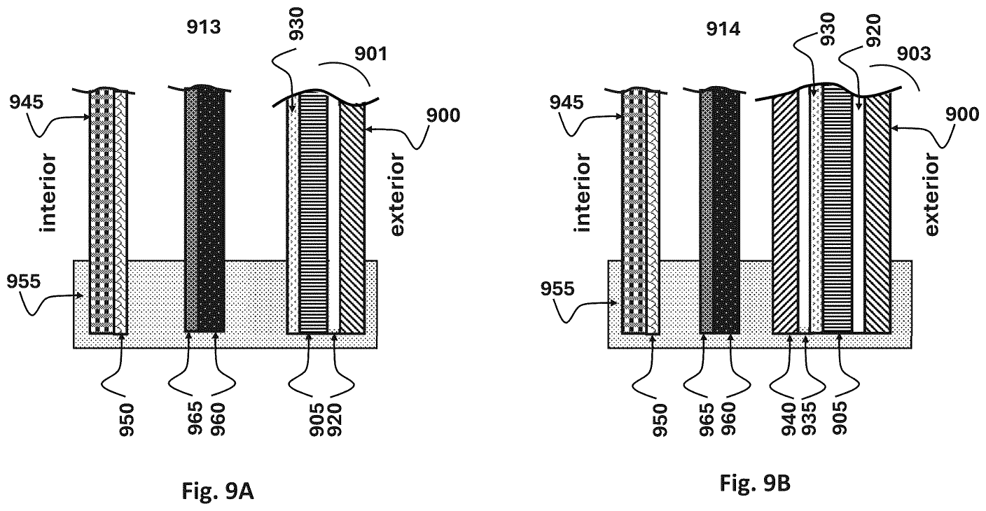

FIG. 9A demonstrates an IGU comprising coated hybrid composite 901 on the exterior side, single transparent pane 945, such as glass or plastic on the interior side, and central single pane 960, such as glass or plastic. Pane 960 may optionally be coated with coating 965, such as a solar-control or ant-reflective coating. The purpose of central pane 960 is to further improve thermal insulation of the IGU. Only the option with no hard coating is shown.

FIG. 9B demonstrates an IGU comprising enhanced coated hybrid composite 903 on the exterior side, single transparent pane 945 on the interior side, and central single pane 960, such as glass or plastic. Pane 960 may optionally be coated with coating 965, such as a solar-control or ant-reflective coating. The purpose of central pane 960 is to further improve thermal insulation of the IGU. Only the option with no hard coating is shown.

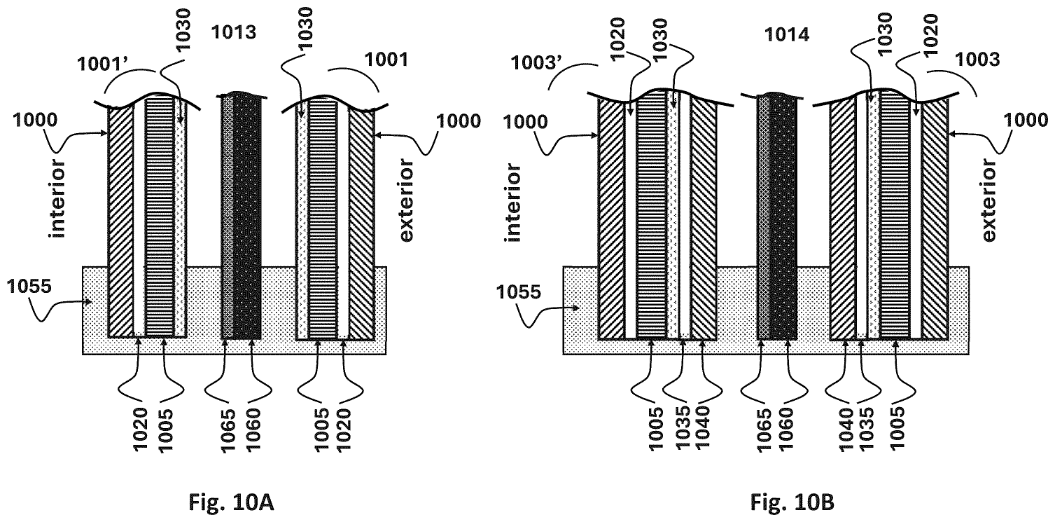

FIG. 10A demonstrates an IGU comprising coated HyC 1001 on the exterior side, its “mirror” double 1001′ on the interior side, and central single pane 1060, such as glass or plastic. Pane 1060 may optionally be coated with coating 1065, such as a solar-control or ant-reflective coating. The purpose of central pane 1060 is to further improve thermal insulation of the IGU. Only the option with no hard coating is shown.

FIG. 10B demonstrates an IGU comprising enhanced coated hybrid composite 1003 on the exterior side, its “mirror” double 1003′ on the interior side, and central single pane 1060, such as glass or plastic. Pane 1060 may optionally be coated with coating 1065, such as a solar-control or ant-reflective coating. Only the option with no hard coating is shown.

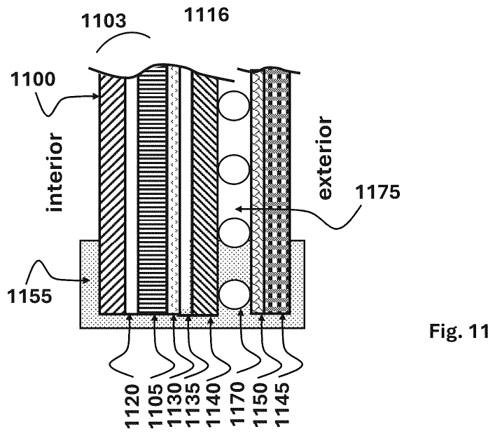

FIG. 11 demonstrates a VIG comprising enhanced coated hybrid composite 1103 on the interior side and single transparent glass pane 1145 on the exterior side. Pane 1145 may optionally be coated with coating 1150. Pane 1145 is spaced from enhanced coated hybrid composite 1103 with spacers 1170 made, e.g., of small, from about 1 to about 3 mm transparent PMMA spheres. Space between enhanced coated HyC 1103 and pane 1145 is filled with vacuum. Vacuum improves thermal insulation of the unit by minimizing heat transfer by connection between the panes. Only the option with no hard coating is shown.

Examples of the exemplified embodiments are presented below. The disclosed examples are illustrative and should not be considered as restrictive.

### Example 1

Example one is a coated hybrid composite. A HyC is first formed comprising a 0.7 mm thick aluminosilicate glass pane bonded with a 5 mm thick PMMA pane using a 0.2 mm thick OCA layer. The hybrid composite is primed after bonding with a 1 mm thick hard coating comprising siloxane applied by wet deposition and then cured with a source of UV light. Hard coating is then patterned using laser scribing. The primed HyC is then coated with a solar-control coating comprising two silver functional layers. The layer stack, starting from the substrates is as follows: SiON (20 nm)/AlN (30 nm)/Ag (10 nm)/AlN (40 nm)/Ag (12 nm)/AlN (30 nm)/SiO₂ (25 nm). The resultant coated hybrid composite is then bonded to an additional thin glass pane, 0.7 mm thick with a second layer of OCA to form an enhanced coated HyC. Transmittance and film-side reflected colors of the enhanced coated hybrid composite in the CIELAB chromaticity space are as follows: T(8°): a*=0.7, b*=3.2; R(8°): a*=−0.3, b*=−8.2.

### Example 2

Example two is a two-pane cooler IGU using an enhanced coated HyC. The HyC is first formed comprising a 0.5 mm thick aluminosilicate glass pane bonded with a 6 mm thick PC pane using a 0.76 mm thick PVB thermoplastic layer. The hybrid composite is primed after bonding with a 0.8 mm thick hard coating comprising siloxane applied by wet deposition and then cured with a source of UV light. Hard coating is not patterned. The primed HyC is then coated with a solar-control coating comprising one silver functional layers. The layer stack, starting from the substrates is as follows: Si₃N₄ (15 nm)/AlN (25 nm)/Ag (15 nm)/AlN (35 nm)/SiO₂ (30 nm). A second pane of aluminosilicate glass, 0.5 mm thick, is then bonded to the coated side of the coated HyC using a second layer of PVB, 0.76 mm thick. The resultant enhanced coated HyC is used in an IGU on its interior side. On the exterior side, an uncoated PMMA single pane, 3 mm thick is installed. Transmittance and interior-side reflected colors of the enhanced coated hybrid composite in the CIELAB chromaticity space are as follows: T(8°): a*=−1.6, b*=1.4; R(8°): a*=−0.5, b*=−5.4.

### Example 3

Example three is a triple-pane IGU fenestration using an enhanced coated HyC of Example two on its outermost sides, with their glass sides facing the interior and exterior. The central pane is a single PMM pane, 3 mm thick, coated with a low-E coating facing the exterior side. The low-E coating is the following thin-film stack, starting from the plastic side: Si₃N₄ (20 nm)/ITO(100 nm)/SiO₂ (25 nm). Transmittance and interior-side reflected colors of the enhanced coated hybrid composite in the CIELAB chromaticity space are as follows: T(8°): a*=−2.0, b*=1.5; R(8°): a*=−1.2, b*=−3.2.

### Example 4

Example four is a double-pane VIG glazing using an enhanced coated HyC of Example two on its interior side. The exterior pane is an uncoated soda-lime glass pane, 3 mm thick. The spacers are PMMA speres, 1 mm thick. Transmittance and film-side reflected colors of the enhanced coated hybrid composite in the CIELAB chromaticity space are as follows: T(8°): a*=−14, b*=2.8; R(8°): a*=−1.6, b*=−3.9.

1. A method of making a coated hybrid composite, the method comprising:
providing an optically transparent plastic pane having a thickness from about 1.0 to about 16.0 mm;
providing an optically transparent thin glass pane having a thickness from about 0.025 to about 2.1 mm;
preparing a surface of each pane using at least one of the following methods of washing, plasma treatment, and chemical activation;
bonding said glass and plastic panes with the prepared surface of the thin glass pane being bonded to the prepared surface of the plastic pane; and
depositing a solar-control coating or a low-emissivity coating on a top surface of the plastic pane of the hybrid composite.

2. The method according to claim 1, wherein the plastic pane comprises polycarbonate, and wherein bonding the plastic pane to the thin glass pane is performed using a thermoplastic interlayer applied to the prepared surfaces.

3. The method according to claim 2, wherein the thermoplastic interlayer is any one of polyvinyl butyral, thermoplastic polyurethane, and ethylene vinyl acetate, said thermoplastic interlayer having a thickness ranging from about 0.2 to about 2.4 mm.

4. The method according to claim 3, wherein the thermoplastic interlayer has a thickness ranging from about 0.3 to about 0.8 mm.

5. The method according to claim 1, wherein the optically transparent thin glass pane comprises any one of soda lime glass, aluminum borosilicate glass, alkali-aluminosilicate glass, and boro-aluminosilicate glass.

6. The method according to claim 1, wherein the plastic pane is an acrylic pane.

7. The method according to claim 6, wherein bonding the acrylic pane to the thin glass pane is performed by gluing the prepared surfaces together using an optically clear adhesive at a temperature at or below 102° C.

8. The method according to claim 1, wherein a hard coating is siloxane based and is applied by wet processing on the prepared plastic surface of the hybrid composite prior to the solar-control or low-emissivity coating deposition.

9. The method according to claim 1, wherein the solar-control coating is inclusive of at least one silver layer ranging in thickness from about 5 to about 20 nm.

10. The method according to claim 1, wherein the low-emissivity coating includes a layer of indium-tin-oxide ranging in thickness from about 70 to about 120 nm.

11. The method according to claim 1, wherein the optically transparent plastic pane has a thickness from about 3.0 to about 6.0 mm.

12. The method according to claim 1, wherein the thin glass pane has a thickness from about 0.5 to about 1.5 mm.

13. The method according to claim 1, further comprising bonding a top of the solar-control coating or a top of the low-emissivity coating to a second pane of thin glass ranging in thickness between about 0.025 and about 2.1 mm to produce an enhanced hybrid composite.

14. The method according to claim 13, wherein the second pane of thin glass has a thickness ranging between about 0.025 and about 1.5 mm.

15. The method according to claim 13, wherein the second thin glass pane comprises any one of soda lime glass, aluminum borosilicate glass, alkali-aluminosilicate glass, and boro-aluminosilicate glass.

16. The method according to claim 13, wherein the second thin pane of glass is bonded to the top of the solar-control coating or the top of the low-emissivity coating using any one of polyvinyl butyral (PVB), ethylene vinyl acetate (EVA), or thermoplastic polyurethane (TPU).

17. The method according to claim 13, including incorporating the enhanced hybrid composite into an insulated glass unit (IGU) structure made by assembling in a frame a single coated or uncoated glass or plastic pane facing the interior of the IGU with the enhanced hybrid composite facing the exterior of the IGU with its glass surface and spaced from the single coated or uncoated glass or plastic pane, thus leaving the coated plastic surface protected inside the IGU to produce a double-pane IGU.

18. The method according to claim 17, wherein the IGU is a vacuum insulating glass unit (VIG) produced by evacuating air from between the panes to produce a vacuum and sealing the insulating glass unit to seal the vacuum.

19. The method according to claim 14, including incorporating the enhanced hybrid composite into an insulated glass unit (IGU) structure made by assembling in a frame a single coated or uncoated glass or plastic pane facing the interior, with the enhanced hybrid composite facing the exterior with its glass surface, and a central single pane made of uncoated glass or plastic positioned between said uncoated glass pane and coated hybrid composite.

20. The method according to claim 19, wherein the IGU is a vacuum insulating glass (VIG) unit produced by evacuating air from between the panes to produce a vacuum and sealing the insulating glass unit to seal the vacuum.
